(19) United States
(12) Patent Application Publication
(10) Pub. No.: US 2013/0086083 A1
(43) Pub. Date: Apr. 4, 2013

(54) TRANSFERRING RANKING SIGNALS FROM EQUIVALENT PAGES

(71) Applicants: YI ZOU, Bellevue, WA (US); YAHOR KISHYLAU, Bellevue, WA (US); SIMON JULIAN POWERS, Seattle, WA (US)

(72) Inventors: YI ZOU, Bellevue, WA (US); YAHOR KISHYLAU, Bellevue, WA (US); SIMON JULIAN POWERS, Seattle, WA (US)

(73) Assignee: MICROSOFT CORPORATION, Redmond, WA (US)

(21) Appl. No.: 13/250,366

(22) Filed: Sep. 30, 2011

(51) Int. Cl. G06F 17/30

(52) U.S. Cl. 707/749; 707/E17.005

(57) ABSTRACT

Methods, computer systems, and computer-storage media for transferring ranking signals from equivalent pages to master pages are provided. In embodiments, ranking signals are received. Documents are determined to be equivalent pages. Master pages for the equivalent pages are identified. The ranking signals are transferred to the master pages.

### BACKGROUND

Various methods for search and retrieval of information, such as by a search engine over a wide area network, are known in the art. Search engine systems store, process, and index content that has value for end-users. Some content, such as content indexed for duplicate, redirect, and canonical sources, distort the value because equivalent master documents already exist in the index.

Simply dropping such duplicate pages from the index degrades the search engine's relevance because the dropped page may have more and/or better ranking signals than the master document retained in the index. Such ranking signals include anchor texts, clicks, and the like. End-users looking for an expected page will perceive the search results as insufficient if the expected page is dropped and the master document does not show up in the search engine results page (SERP).

Similarly, another problem with equivalent uniform resource locators (URLs) in an index is that the ranking signals are stored individually for each equivalent URL. This results in the relevance for the ranking signals to be split according to the equivalent URL to which each respective ranking signal was contributed. This results in some relevant documents not appearing in the SERP because ranking signals are dispersed across the equivalent URLs.

### SUMMARY

Embodiments of the present invention relate to systems, methods, and computer-readable media for, among other things, transferring ranking signals from equivalent pages to a master page. In this regard, embodiments of the present invention receive one or more ranking signals for a document. The document is determined to be an equivalent page. A master page associated with the equivalent page is identified. Ranking signals associated with the equivalent page are communicated to the master page.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 schematically shows a network environment suitable for performing embodiments of the invention.

FIG. 3 is a flow diagram showing a method for transferring ranking signals from an equivalent to a master page, in accordance with an embodiment of the present invention; and

FIG. 4 is a flow diagram showing a method for reassociating ranking signals for a non-equivalent page, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The following definitions are used to describe aspects of transferring ranking signals from an equivalent page to a master page. An equivalent page is a duplicate page, a near duplicate page, or a redirect page. A near duplicate page is a page that is not an exact duplicate page, but may have slight differences that do not detract from the content of the page and does not provide any additional information or value to a user. For example, a near duplicate page may have identical content but different advertisements. In another example, a near duplicate page may have identical content but a different timestamp or IP address of a web server from which the page was served. A master page may indicate a landing page that is rendered when a redirect page redirects. A redirect page may indicate a page that redirects to a landing page or redirects via canonical URL tags, JavaScript instructions, or meta-refresh tags. Other methods for identifying a master page will be described herein. A static rank is used to describe the authority of the documents based on anchor links. A domain rank describes the authority of the domain. A tool bar domain hits counter identifies the number of visits to the domain from the tool bar. A tool bar domain users count identifies the number of unique visitors to the domain from the tool bar. A junk page measure represents a confidence of how likely a document's content does not provide any useful information. A spam page measure represents a confidence of how likely a document and documents that link to it are employing spam tactics. An anchor most frequent count identifies the total frequency of the most frequent terms in the anchor text. A body most frequent count identifies the total frequency of the most frequent terms in the body of the document. An anchor unique phrase count is the number of unique anchor texts pointing to a given document. An anchor total phrase count represents the total number of anchor texts pointing to a given document. An anchor unique term count is the total number of unique terms in anchor text. A body unique term count is the total number of unique terms in the body of the document. A body term count is the total number of terms in the body of the document. A top level domain rating identifies whether the domain is well known, or highly authoritative, domain or not. A words in domain count represents the number of words in the domain portion of a uniform resource locator (URL). A words in path count represents the number of words in the path portion of the URL. A words in title count represents the number of words in the title of a web page. A total anchor count is the number of links pointing to a given web page. A number of entries in the Open Directory Project count identifies the number of entries for a particular web page in the Open Directory Project, located at www.dmoz.org. A tool bar URL hits counter identifies the number of visits to a web page from the tool bar. A tool bar URL users counter identifies the number of unique visitors to the web page from the tool bar.

Embodiments of the present invention relate to systems, methods, and computer storage media having computer-executable instructions embodied thereon that transfer ranking signals from equivalent pages to master pages. In this regard, embodiments of the present invention provide a more accurate SERP even when a particular relevant has many equivalent URLs. Ranking signals are received for documents. If documents are determined to be equivalent pages, master pages for each equivalent page are identified. The ranking signals for each equivalent page are communicated to its respective master page.

Accordingly, in one aspect, the present invention is directed to computer storage media having computer-executable instructions embodied thereon, that when executed, cause a computing device to perform a method for transferring ranking signals from an equivalent page to a master page. The method includes receiving one or more ranking signals for a document. The document is determined to be an equivalent page. A master page associated with the equivalent page is identified. The ranking signals associated with the equivalent page are communicated to the master page.

In yet another aspect, the present invention is directed to computer storage media having computer-executable instructions embodied thereon, that when executed, cause a computing device to perform a method for reassociating ranking signals for a non-equivalent page. The method includes determining an equivalent page to a master page is a non-equivalent page. It is communicated to the master page that the non-equivalent page is no longer an equivalent page. The ranking signals associated with the non-equivalent page are dropped from the master page. The ranking signals are reassociated.

In another aspect, the present invention is directed to a computer system, comprising a processor coupled to a computer-storage medium, the computer-storage medium having stored thereon a plurality of computer software components executable by the processor for predicting transferring ranking signals from an equivalent page to a master page. The computer software components include an equivalent page detecting component for detecting that more than one page are equivalents. A master page selection component determines a master page from the more than one equivalent page. A transfer component transfers the ranking signals from the more than one equivalent page to the master page.

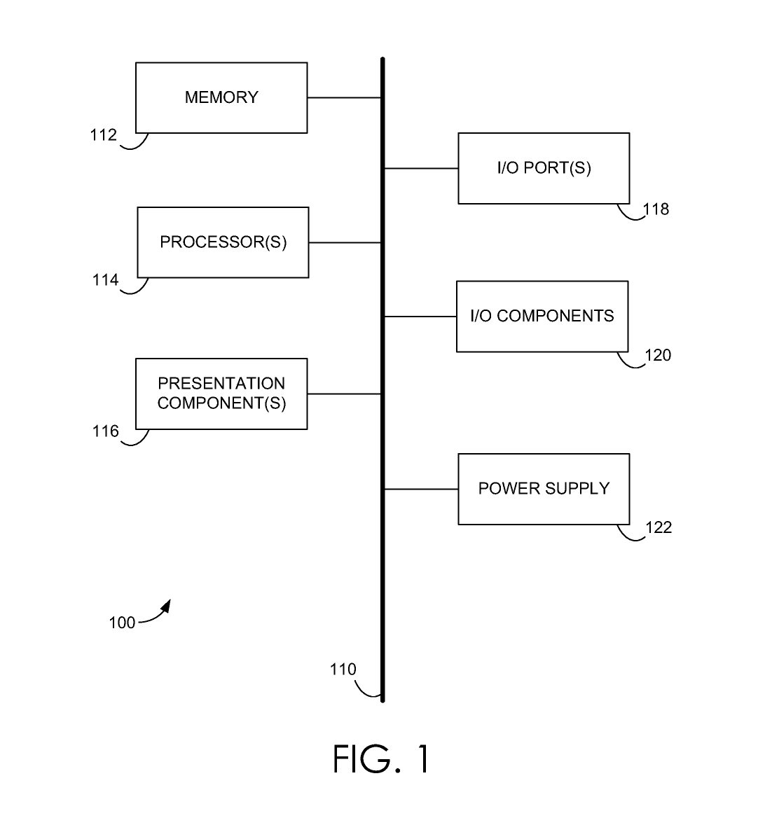

Having briefly described an overview of the present invention, an exemplary operating environment in which various aspects of the present invention may be implemented is described below in order to provide a general context for various aspects of the present invention. Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

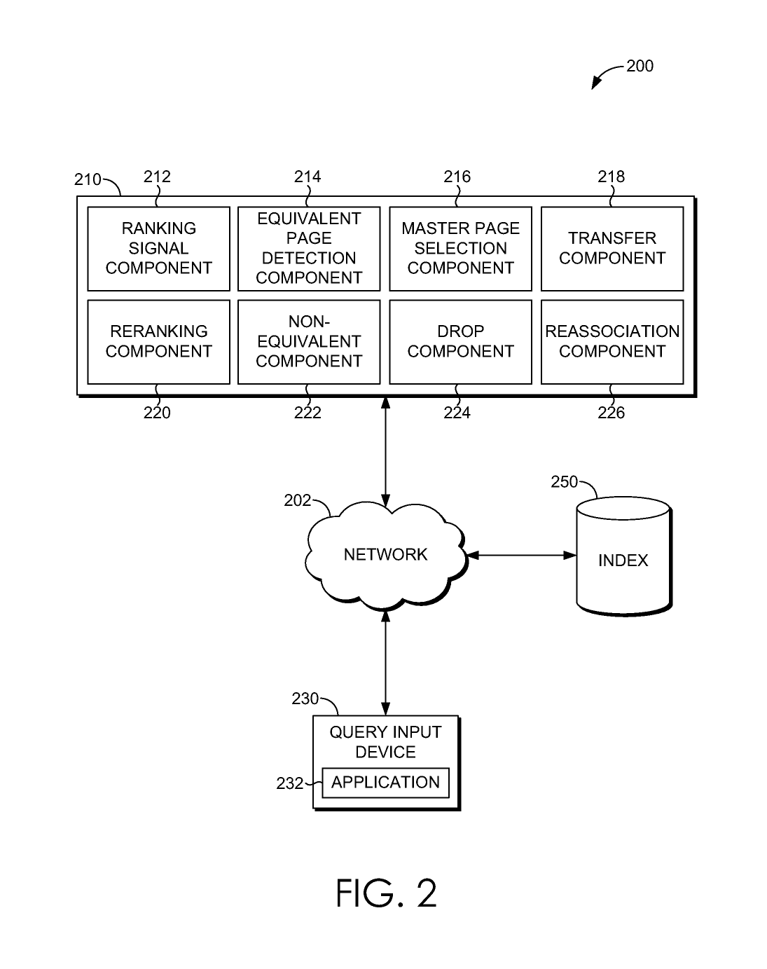

With reference to FIG. 2, a block diagram is illustrated that shows an exemplary computing environment 200 configured for use in implementing embodiments of the present invention. It will be understood and appreciated by those of ordinary skill in the art that the environment 200 shown in FIG. 2 is merely an example of one suitable environment and is not intended to suggest any limitation as to the scope of use or functionality of the present invention. Neither should the environment 200 be interpreted as having any dependency or requirement related to any single module/component or combination of modules/components illustrated therein.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

FIG. 2 schematically shows a computing system architecture 200 suitable for performing embodiments of the invention. It will be understood and appreciated by those of ordinary skill in the art that the computing system architecture 200 shown in FIG. 2 is merely an example of one suitable computing system and is not intended to suggest any limitation as to the scope of use or functionality of the present invention. Neither should the computing system architecture 200 be interpreted as having any dependency or requirement related to any single module/component or combination of modules/components illustrated therein.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

With continued reference to FIG. 2, the computing system architecture 200 includes a network 202, a search engine server 210, a query input device 230, and an index 250.

The network 202 includes any computer network such as, for example and not limitation, the Internet, an intranet, private and public local networks, and wireless data or telephone networks.

The query input device 230 is any computing device, such as the computing device 100, capable of running an application 232, from which a search query can be initiated. For example, the query input device 230 might be a personal computer, a laptop, a server computer, a wireless phone or device, a personal digital assistant (PDA), or a digital camera, among others. It should be noted, however, that embodiments are not limited to implementation on such computing devices, but may be implemented on any of a variety of different types of computing devices within the scope of embodiments hereof. In an embodiment, a plurality of query input devices 230, such as thousands or millions of query input devices 230, is connected to the network 202.

The search engine server 210 includes any computing device, such as the computing device 100, and provides at least a portion of the functionalities for providing a search engine. In an embodiment a group of search engine servers 210 share or distribute the functionalities for providing search engine operations to a user population.

Components of the query input device 230 and the search engine server 210 may include, without limitation, a processing unit, internal system memory, and a suitable system bus for coupling various system components, including one or more databases for storing information (e.g., files and metadata associated therewith). Each of the query input device 230 and the search engine server 210 typically includes, or has access to, a variety of computer-readable media.

The search engine server 210 is communicatively coupled to an index 250. The index 250 includes any available computer storage device, or a plurality thereof, such as a hard disk drive, flash memory, optical memory devices, and the like. The index 250 provides a web page index for identifying web documents available via network 202. The index 250 may utilize any indexing data structure or format. When searching for a document associated with a particular query, the index is traversed to identify documents associated with that query. In one embodiment, search results are presented according to ranking signals associated with the document (i.e., a document with a higher valued or more ranking signals is presented higher in the list of search results than a document with a comparatively lower valued or less ranking signals). In an embodiment, the search engine server 210 and index 250 directly communicatively coupled so as to allow direct communication between the devices without traversing the network 202.

It will be understood by those of ordinary skill in the art that computing system architecture 200 is merely exemplary. While the search engine server 210 is illustrated as a single unit, one skilled in the art will appreciate that the search engine server 210 is scalable. For example, the search engine server 210 may in actuality include a plurality of computing devices in communication with one another. Moreover, the index 250, or portions thereof, may be included within the search engine server 210. The single unit depictions are meant for clarity, not to limit the scope of embodiments in any form.

As shown in FIG. 2, the search engine server 210 includes, among other components, a ranking signal component 212, an equivalent page detection component 214, a master page selection component 216, an transfer component 218, a reranking component 220, a non-equivalent component 222, a drop component 224, and a reassociation component 226

In one embodiment, a ranking signal component 212 receives ranking signals from the query input device 230. Such ranking signals include anchor text, user click data, metadata, and the like. As can be appreciated, various sets of metadata can be attached to each document to help rank the documents. In many instances, the metadata is query independent. For example, query independent properties include a static rank, a domain rank, a tool bar domain hit count, a tool bar domain user count, a junk page measure, a spam page measure, an anchor most frequent count, a body most frequent count, an anchor unique phrase count, an anchor total phrase count, an anchor unique term count, a body term count, a top level domain rating, a words in domain count, a words in path count, a words in title count, a total anchor count, a number of entries in the Open Directory Project count, a tool bar uniform resource locator hit count, a tool bar uniform resource locator user count, or any combination thereof. As can be appreciated, many other query independent properties may be extracted from the plurality of web pages.

There are multiple ways to extract metadata. The metadata extraction technique may be predetermined or it may be selected dynamically either by a person or an automated process. Metadata extraction techniques can include, but are not limited to: (1) parsing the filename for embedded metadata; (2) extracting metadata from the document; (3) extracting the surrounding text in a web page where a digital object is hosted; (4) extracting annotations and commentary associated with the document; and (5) extracting query keywords that were associated with the document when a user selected the document after a text query. In other embodiments, metadata extraction techniques may involve other operations.

Some of the metadata extraction techniques start with a body of text and sift out the most concise metadata. Accordingly, techniques such as parsing against a grammar and other token-based analysis may be utilized. For example, surrounding text for an image may include a caption or a lengthy paragraph. At least in the latter case, the lengthy paragraph may be parsed to extract terms of interest. By way of another example, annotations and commentary data are notorious for containing text abbreviations (e.g. IMHO for “in my humble opinion”) and emotive particles (e.g. smileys and repeated exclamation points). IMHO, despite its seeming emphasis in annotations and commentary, is likely to be a candidate for filtering out where searching for metadata.

In the event multiple metadata extraction techniques are chosen, a reconciliation method can provide a way to reconcile potentially conflicting candidate metadata results. Reconciliation may be performed, for example, using statistical analysis and machine learning or alternatively via rules engines.

An equivalent page detection component 214 detects that more than one page are equivalents. In one embodiment, a redirect page is an equivalent page. In another embodiment, a duplicate page is an equivalent page. In yet another embodiment, a near-duplicate page is an equivalent page. As can be appreciated, any number of pages may be considered equivalents. Each equivalent page has its own set of ranking signals associated with it to help the search engine ranking algorithm rank the page. This ranking affects the order of the SERP when a user submits a search query.

A master page selection component 216 determines a master page from the more than one equivalent page. This can be accomplished in several ways. For example, several pages identified as equivalents may all redirect to a common landing page. In this scenario, the landing page will be selected by the master page selection component 216 as the master page. In another example, equivalent pages may redirect to multiple landing pages. In this scenario, the multiple landing pages are unstable so they are not automatically selected as the master. Internal signals, such as the landing page with the highest page rank, may be utilized to select a master page. These internal signals may also be utilized to select a master page when the equivalents are duplicates or near-duplicates. If the page with the highest static rank has a long URL, another page with a slightly lower static rank may be selected if it has a shorter URL. In another embodiment, the master page refers to a composite document or indexing entry. In this example, a single master page is not elected from the equivalent pages. Rather, all equivalent pages are indexed as a single composite document where all ranking information is combined. As can be appreciated, other query independent signals may similarly be used to select the master page. Once the master page is selected, it is identified as the master page within the index.

A transfer component 218 transfers the ranking signals from the more than one equivalent page to the master page. In one embodiment, messages of various types that contain corresponding ranking signals are communicated to the master page and stored in the index. For example, click data message, represented by pairs of phrases and scores calculated externally are communicated to the master page. In addition, anchor text message, containing information about the anchor source and what the anchor text describes, are also communicated to the master page. As can be appreciated, any type of metadata may be communicated to the master page and utilized by various embodiments of the present invention. When the master page receives a message, it stores the data and associates the data with the source URL. An updated tree of equivalent URLs, or a mapping of all equivalent pages, is also stored with each master page in the index. Similarly, the corresponding ranking signals for each equivalent page is also stored with the appropriate master page in the index. Both the tree of equivalent URLs and corresponding ranking signals are regularly updated.

A reranking component 220, in one embodiment, reranks the master page utilizing the ranking signals transferred from equivalent pages. When the index content of the master page is updated, the click signal is combined with an algorithm that is utilized by the ranking engine. In one embodiment, the phrase and scores intended for the master page is preferred. Click signals from higher-static-rank equivalents are utilized next. In one embodiment, the order of phrase and scores at which they are indexed is strictly respected. For example, for phrases that have duplicates among the master and equivalents' ranking signals, the phrase is kept intact and the score is indexed with the highest score available. In another embodiment, the scores are aggregated and stored with the master page. In another embodiment, higher query-independent scores are calculated from a variety of page features using techniques such as heuristics, machine learning algorithms and rule engines to maximize a final relevance metric. The final relevance metric is utilized by the ranking engine to rerank the master page.

In another embodiment a non-equivalent component 222 determines that an equivalent page is a non-equivalent page. For example, an equivalent URL relationship may no longer be valid if a redirect source starts to point to a different target. In this scenario, the previous master page is notified by a message. The next time the master page is processed, a drop component 224 will delete all the ranking signals from the now-expired redirect source. Similarly, the tree of equivalent URLs will be updated by the drop component 224 to remove the non-equivalent page.

In one embodiment, a reassociation component 226 will reassociate the non-equivalent page to a new master page as described above. In another embodiment, a new master page will not be identified and the reassociation component 226 will reassociate the ranking signals of the non-equivalent page to itself.

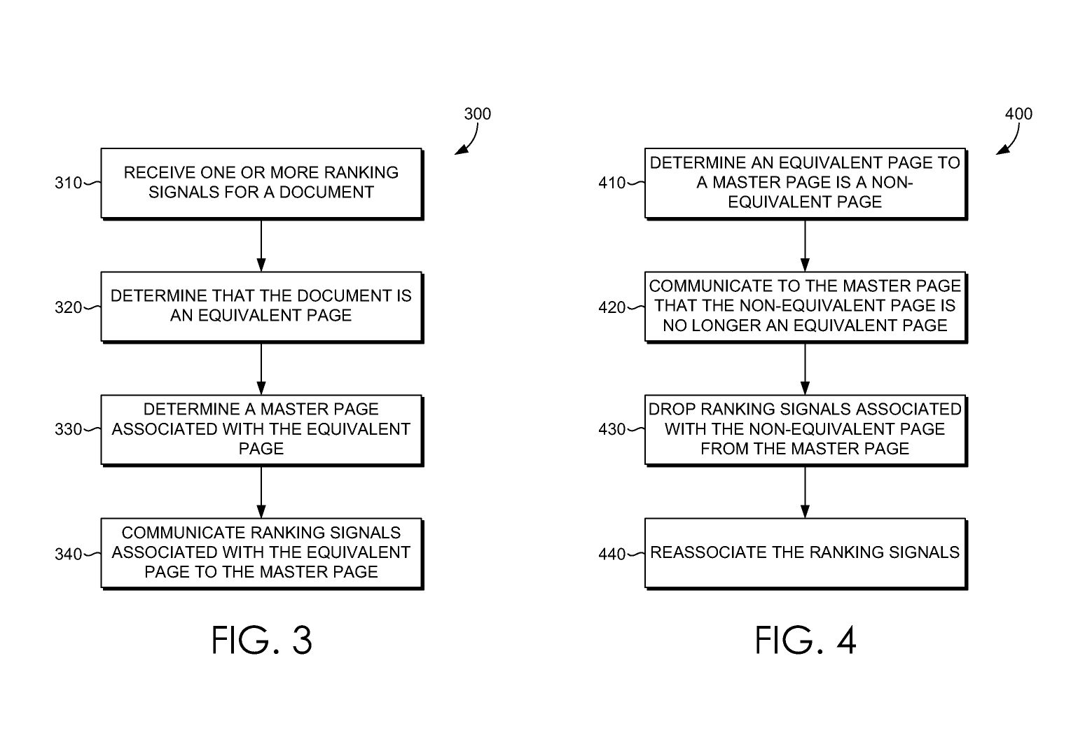

Referring now to FIG. 3, a flow diagram 300 illustrates a method for transferring ranking signals from an equivalent to a master page, in accordance with an embodiment of the present invention. At step 310, one or more ranking signals are received for a document. In various embodiments, the ranking signals comprise anchor text and/or user click data. The document is determined to be an equivalent page at step 320. In one embodiment, the equivalent page is a duplicate page. In another embodiment, the equivalent page is a near-duplicate page. In yet another embodiment, the equivalent page is a redirect page. A master page associated with the equivalent page, at step 330, is identified. In one embodiment, identifying a master page comprises identifying a page associated with the equivalent page that has the highest static rank. In another embodiment, identifying a master page comprises identifying a page associated with the equivalent page that has the shortest URL and has one of the highest static ranks. In another embodiment, identifying a master page comprises identifying a landing page.

Once the master page is identified, ranking signals associated with the equivalent page are communicated to the master page, at step 340. In one embodiment, click data messages are communicated to the master page. In another embodiment, anchor text messages are communicated to the master page.

In one embodiment, the master page is reranked within the index. In one embodiment, a click signal is combined with an algorithm comprising a phrase and score intended for the master document and click signals from higher-static rank equivalent pages. In one embodiment, the phrase and scores intended for the master page is preferred. In one embodiment, click signals from higher-static-rank equivalent pages are utilized next. In one embodiment, the order of phrase and scores at which they are indexed is strictly respected. For example, for phrases that have duplicates among the master and equivalents' ranking signals, the phrase is kept intact and the score is indexed with the highest score available. In another embodiment, the scores are aggregated and stored with the master page.

In one embodiment, a tree of equivalent pages and corresponding ranking signals is maintained with each master page stored in the index. The tree is continuously updated when additional equivalent or non-equivalent documents are detected. In one embodiment, a page is determined to no longer be an equivalent page. In this scenario, the non-equivalent page and its corresponding ranking signals are removed from the tree.

Referring now to FIG. 4, a flow diagram 400 illustrates a method for reassociating ranking signals for a non-equivalent page, in accordance with an embodiment of the present invention. At step 410, an equivalent page to a master page is determined to be a non-equivalent page. For example, the equivalent page may have, at one time, redirected to the master page. However, if the landing page has changed, then the equivalent page is no longer an equivalent page, or more simply, a non-equivalent page. Similarly, if the equivalent page was a duplicate or non-duplicate page, and the content of the equivalent page changed such that the equivalent page is no longer an equivalent page, then the equivalent page is determined to be a non-equivalent page. At step 420, it is communicated to the master page that the non-equivalent page is no longer an equivalent page. The ranking signals associated with the non-equivalent page are dropped from the master page at step 430. At step 440, the ranking signals are reassociated. In one embodiment, the ranking signals are reassociated with the non-equivalent page. In another embodiment, the ranking signals are reassociated with a new master page.

It will be understood by those of ordinary skill in the art that the order of steps shown in the method 300 and 400 of FIGS. 3 and 4 respectively are not meant to limit the scope of the present invention in any way and, in fact, the steps may occur in a variety of different sequences within embodiments hereof. Any and all such variations, and any combination thereof, are contemplated to be within the scope of embodiments of the present invention.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. Computer-storage media storing computer-useable instructions, that, when executed by a computing device, perform a method for transferring ranking signals from an equivalent page to a master page, the method comprising:
receiving one or more ranking signals for a document;
determining that the document is an equivalent page;
identifying a master page associated with the equivalent page; and
communicating ranking signals associated with the equivalent page to the master page.

2. The media of claim 1, further comprising reranking the master page.

3. The media of claim 1, wherein reranking the master page comprises combining a click signal with an algorithm comprising a phrase and score intended for the master page and click signals from higher-static-rank equivalent pages.

4. The media of claim 1, wherein the ranking signals comprise anchor text, user click data, or other ranking signals.

5. The media of claim 1, wherein identifying a master page comprises identifying a page associated with the equivalent page with the highest static rank.

6. The media of claim 1, wherein identifying a master page comprises identifying a landing page.

7. The media of claim 1, wherein the equivalent page comprises a duplicate or redirect page.

8. The media of claim 1, wherein communicating ranking signals comprises communicating click data messages to the master page.

9. The media of claim 1, wherein communicating ranking signals comprises communicating anchor text messages to the master page.

10. The media of claim 1, further comprising maintaining a tree of equivalent pages and corresponding ranking signals with each master page.

11. The media of claim 10, further comprising determining a page is no longer an equivalent page.

12. The media of claim 11, further comprising removing the non-equivalent URL and corresponding ranking signals from the tree.

13. Computer-storage media storing computer-useable instructions, that, when executed by a computing device, perform a method for reassociating ranking signals from a master page to a non-equivalent page, the method comprising:
determining an equivalent page to a master page is a non-equivalent page;
communicating to the master page that the non-equivalent page is no longer an equivalent page;
dropping ranking signals associated with the non-equivalent page from the master page; and
reassociating the ranking signals.

14. The media of claim 13, wherein reassociating the ranking signals comprising reassociating the ranking signals with the non-equivalent page.

15. The media of claim 13, wherein reassociating the ranking signals comprises reassociating the ranking signals with a new master page.

16. A computer system for transferring ranking signals from an equivalent page to a master page, the computer system comprising a processor coupled to a computer-storage medium, the computer-storage medium having stored thereon a plurality of computer software components executable by the processor, the computer software components comprising:
an equivalent page detection component for detecting that more than one page are equivalents;
a master page selection component for determining a master page from the more than one equivalent page; and
a transfer component for transferring ranking signals from the more than one equivalent page to the master page.

17. The computer system of claim 16, further comprising a reranking component for reranking the master page.

18. The computer system of claim 16, further comprising a non-equivalent component for determining that an equivalent page is a non-equivalent page.

19. The computer system of claim 18, further comprising a drop component for dropping the ranking signals for the non-equivalent page from the master page.

20. The computer system of claim 19, further comprising a reassociation component for reassociating the non-equivalent page to a new master page.
